(19) United States
(12) Patent Application Publication
(10) Pub. No.: US 2020/0074190 A1
(43) Pub. Date: Mar. 5, 2020

(54) LANE AND OBJECT DETECTION SYSTEMS AND METHODS

(71) Applicant: Buffalo Automation Group Inc., Amherst, NY (US)

(72) Inventors: Mohit Arvind KHAKHARIA, Amherst, NY (US); Thiru Vikram SURESH, Amherst, NY (US); Trevor R. MCDONOUGH, Amherst, NY (US); Miguel Ojielong CHANG LEE, Amherst, NY (US)

(21) Appl. No.: 16/555,631

(22) Filed: Aug. 29, 2019

Related U.S. Application Data
(60) Provisional application No. 62/724,311, filed on Aug. 29, 2018.

(51) Int. Cl. G06K 9/00; G08G 1/16; B60W 30/12; G06N 3/04; G06T 7/70

(52) U.S. Cl. CPC G06K 9/00798; G06K 9/00805; G08G 1/167; B60W 30/12; G06T 2207/30256; G06T 7/70; B60W 2420/42; B60W 2550/10; G06N 3/04

(57) ABSTRACT

Embodiments disclosed herein include systems and methods for lane and object detection. A system may comprise a plurality of cameras and a processor in electronic communication with the cameras. The cameras may be disposed on a vehicle. The cameras may be configured to collect one or more images. The cameras may be configured to generate an image data feed using the one or more images. A method may comprise collecting one or more images; generating, from the one or more images, an image data feed; receiving, at a processor, the image data feed; and performing lane detection and object detection, and may employ a deep learning network.

### CROSS REFERENCE TO RELATED APPLICATIONS

This application claims priority to U.S. Provisional Application No. 62/724,311, filed on Aug. 29, 2018, the entire disclosure of which is hereby incorporated by reference.

### FIELD OF THE DISCLOSURE

The disclosure generally relates to lane and object detection for vehicles.

### BACKGROUND OF THE DISCLOSURE

Vehicle safety is important to consumers and travelers. Some systems exist to warn a driver of a possible impending lane departure. Likewise, some rudimentary systems exist to assist an autonomous or semiautonomous vehicle to detect certain objects. However, such systems generally rely heavily on data repositories and are unable to effectively recognize new objects or lanes in real-time for large vehicles, such as trucks.

Improvements to lane detection or object detection can improve vehicle safety. Therefore, a new technique to operate vehicles, such as trucks, is needed.

### SUMMARY OF THE DISCLOSURE

An embodiment may be a system comprising a plurality of cameras and a processor in electronic communication with the cameras. The cameras may be disposed on a vehicle. The cameras may be configured to collect one or more images. The cameras may be configured to generate an image data feed using the one or more images.

The processor may be in electronic communication with the cameras. The processor may be configured to receive the image data feed from the cameras. The processor may be configured to execute one or more programs.

The programs may comprise a lane detection module or an object detection module.

The lane detection module may be configured to perform lane detection. The lane detection may be performed using the image data feed.

The object detection module may be configured to perform object detection. The object detection may be performed using the image data feed. The object detection module may be configured to identify and classify other vehicles.

The programs may further comprise a deep learning module. The lane detection module or the object detection module may use the deep learning module during operation.

The system may further comprise a data logger. The data logger may be in communication with a component of an engine of the vehicle. The component may be a monitoring system. The data logger may be an electronic logging device. The data logger may be configured to generate a data log.

The system may further comprise an electronic data storage unit. The electronic data storage unit may be in electronic communication with the processor. The electronic data storage unit may be configured to store the image data feed or the data log.

The system may further comprise a reader. The reader may be operatively connected to the processor. The reader may be operatively connected to an electronic data storage unit. The reader may be configured to receive the image data feed or the data log. The reader may be operatively connected to the processor or the electronic data storage unit using wired or wireless communication. The reader may comprise a mobile device or a web interface.

An embodiment may comprise a method. The method may comprise collecting one or more images; generating, from the one or more images, an image data feed; receiving, at a processor, the image data feed; and performing lane detection and object detection.

The collecting or generating may be performed using a plurality of cameras disposed on a vehicle. The lane detection or object detection may be performed on the processor. The lane detection or object detection may use the image data feed.

The object detection may include identifying and classifying another vehicle.

The method may further comprise performing deep learning. The deep learning may be performed using the processor. The deep learning may use the results of the lane detection or the object detection.

The method may further comprise generating a data log. The data log may be generating using a data logger. The data logger may be in electronic communication with a component of an engine of the vehicle. The component may be a monitoring system. The data logger may be an electronic data logging device.

The method may further comprise generating a data log.

The image data feed or the data log may be stored on an electronic data storage unit. The electronic data storage unit may be in electronic communication with the processor.

The method may further comprise alerting a drive of a lane exit. The lane exit alert may be based on a determination of a lane exit by the lane detection.

### BRIEF DESCRIPTION OF THE FIGURES

For a fuller understanding of the nature and objects of the disclosure, reference should be made to the following detailed description taken in conjunction with the accompanying drawings, in which:

FIG. 1 is a block diagram of a system embodiment in accordance with the present disclosure;

FIG. 2 is a block diagram of a web application embodiment in accordance with the present disclosure;

FIG. 3 is a flowchart of an embodiment of a method in accordance with the present disclosure;

FIG. 4 is an exemplary GUI for a mobile application;

FIGS. 5 and 6 are views of cameras mounted on a semi-truck;

FIG. 7 shows exemplary camera calibration;

FIG. 8 shows exemplary distortion removal;

FIG. 9 shows another exemplary distortion removal;

FIG. 10 shows different image channels;

FIG. 11 shows application of exemplary gradient and color thresholds;

FIG. 12 shows original and thresholded binary images;

FIG. 13 shows original and unwarped images;

FIG. 14 illustrates finding lanes in warped images; and

FIG. 15 illustrates plotting a lane quadrilateral.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein include systems and methods for lane and object detection.

Embodiments disclosed herein can be used with trucks or other land vehicles over 10,000 pounds. This includes box trucks, flatbed trucks, and semi-trucks. Other smaller land vehicles also can benefit, as can drones or other vehicles that can fly at low altitudes.

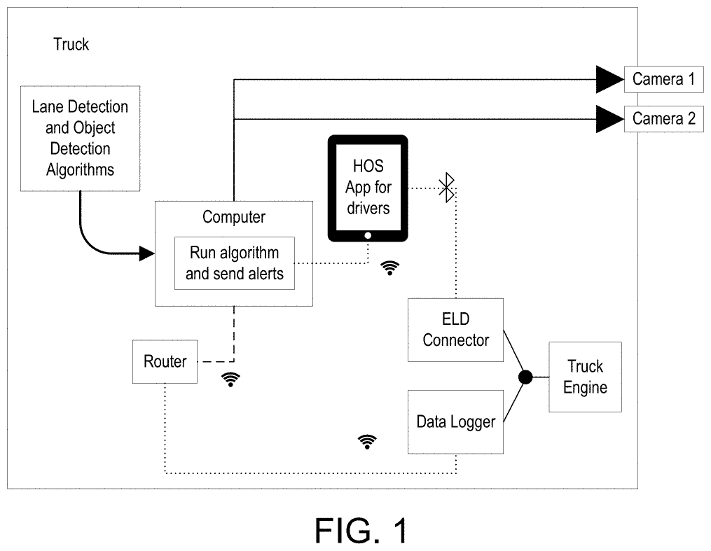

An embodiment may be a system comprising a plurality of cameras and a processor in electronic communication with the cameras. FIG. 1 is a block diagram of a system embodiment. The cameras may be disposed on a vehicle. The cameras may be configured to collect one or more images (e.g., a single image, sequence of images, video feed, and the like). The cameras may be configured to generate an image data feed using the one or more images.

At least two cameras mounted on the vehicle provide images to a computer, which may include one or more processors and one or more electronic data storage units. The computer (e.g., the processor thereon) may include a lane detection module configured to perform lane detection and an object detection module configured to perform object detection. The computer can include lane detection and object detection algorithms. The computer can run these algorithms and send alerts. For example, the computer can wirelessly communicate with a mobile application on the driver's tablet or phone to send alerts. The object detection module is configured to identify and classify objects or other vehicles.

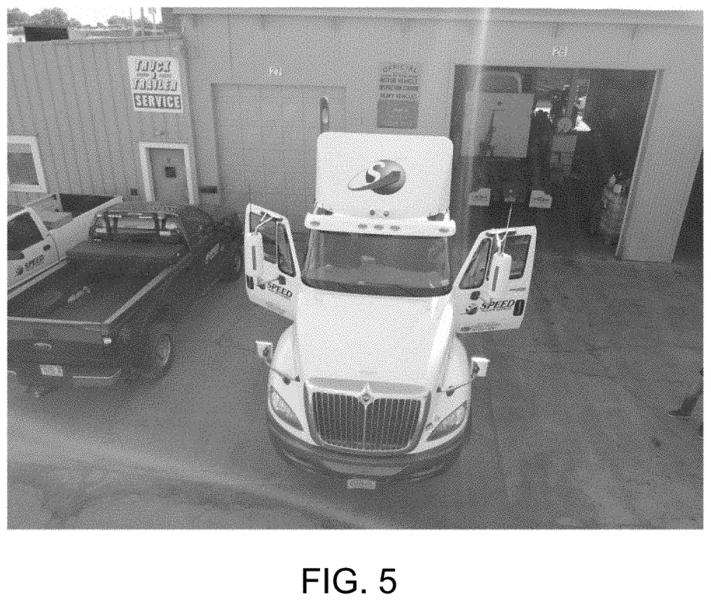

In a non-limiting example, the cameras have specifications including five megapixels (5 MP) and the ability to record in the H.265 format. Such a camera may be an IB9381-EHT VIVOTEK Bullet Network Camera. FIGS. 5 and 6 are views of these cameras mounted on a semi-truck.

In an embodiment, two cameras placed on the truck facing forward can continuously record the feed. The output of the feed can be viewed live by, for example, the administrator of the trucking company. The data from the live feed of the cameras can also be used to run lane detection and object detection algorithms. The algorithm can send alerts to the driver (for example, an alert when the driver moves out of a lane). The alerts are sent via a mobile application, which may be installed on the mobile device (e.g., ANDROID device, IOS device, or other mobile device).

The processor may be in electronic communication with the cameras. The processor may be configured to receive the image data feed from the cameras. The processor may be configured to execute one or more programs.

The programs may comprise a lane detection module or an object detection module.

The lane detection module may be configured to perform lane detection. The lane detection may be performed using the image data feed.

The object detection module may be configured to perform object detection. The object detection may be performed using the image data feed. The object detection module may be configured to identify and classify other vehicles.

An object detection network can be used based on the camera feed. This can identify objects such as cars or other trucks. The object detection network, which can include a convolutional neural network (CNN), can be trained to identify and classify objects in a real-time offline environment. Objects can be identified and classified using the object detection network. The system can identify objects such as cars, trucks, motorcycles, traffic barriers, bridges, obstacles, or other objects in real-time from the image feed received from cameras.

The programs may further comprise a deep learning module. The lane detection module or the object detection module may use the deep learning module during operation, for training the same. The computer also can include a deep learning module. The lane detection module and/or the object detection module can work with the deep learning module during operation. Thus, the deep learning module can be used to detect a lane or detect objects from the images.

In an instance, images can be received by a trained neural network, such as the object detection network. The neural network can be trained online through the cloud. However, the neural network binary can be deployed to an offline system, and can identify objects across particular categories. The neural network can provide a bounding box (e.g., x cross y) around an object in an image, which can size the object in the image. The neural network also can provide a classification of the object in the bounding box with a confidence score.

The identification and the classification can include using a Convolutional Neural Network (CNN) in the form of an object detection network, image segmentation network, or an object identification network. A CNN or other deep learning module in the object determination network can be trained with at least one set of images. As disclosed herein, a CNN is a type of feed-forward artificial neural network in which the connectivity pattern between its neurons (i.e., pixel clusters) is inspired by the organization of the animal visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation. CNNs are discussed in more detail later herein.

The object classification network can perform operations like a scene classifier. Thus, the object classification network can take in an image frame and classify it into only one of the categories.

In one embodiment, three neural networks may be used. One neural network identifies objects in images, one neural network segments the image into regions that need to be classified, and another neural network classifies objects identified by the first neural network. Three neural networks may provide improved object detection speed and accuracy. Three neural networks can also classify the whole scene in the image, including time of day (e.g., dawn, dusk, night), the state of the vessels identified as dynamic or static, and/or classify the objects identified by the object detection network.

In another embodiment, two neural networks may be used. One neural network identifies objects in images and another neural network classifies objects identified by the first neural network. Two neural networks may provide improved object detection speed and accuracy. Two neural networks can also classify the whole scene in the image, including time of day (e.g., dawn, dusk, night), the state of the vessels identified as dynamic or static, and/or classify the objects identified by the object detection network.

In another embodiment, a single neural network may identify objects in an image and classify these objects. In the embodiment with a single neural network, a second validation neural network can optionally be used for verification of the identification and classification steps. If the deep learning model outputs a classification for an object detected in the image, the deep learning model may output an image classification, which may include a classification result per image with a confidence associated with each classification result. The results of the image classification can also be used as described further herein. The image classification may have any suitable format (such as an image or object ID, an object description such as “truck,” etc.). The image classification results may be stored and used as described further herein.

The computer in FIG. 1 also can perform data collection.

The system may further comprise a data logger. The data logger may be in communication with a component of an engine of the vehicle. The component may be a monitoring system. The data logger also can communicate with the computer, such as using a wireless connection.

The data logger may be an electronic logging device (ELD). The ELD system may be approved and certified by the Federal Motor Carrier Safety Administration (FMCSA). The ELD system may include both a data logger and ELD connection, both of which may be in electronic communication with components of the engine. For example, the data logger and ELD connection may be in electronic communication with a monitoring system for the engine.

In an embodiment, a Y-connector is connected to the J1939 port of the truck. One of the two ports is connected to ELD Connector. The other port is connected to a Data Logger. The ELD connector collects data and it is connected to a mobile device (e.g., an ANDROID device, IOS device, or other mobile device) via Bluetooth or other wired or wireless communication techniques. The ANDROID device has a mobile application which evaluates driver logs and other logistics. The ANDROID application can be used by the driver. This application can include all features necessary for HOS regulations.

The data logger may be configured to generate a data log. The data logger can collect user-specified parameters. The data logger can store information in a microSD card. When the truck reaches a home terminal, it can upload the data into a locally hosted WAMP server via WiFi. This data can be used for future enhancement and automation of trucks. For example, the data can be used to provide training image sets for self-driving vehicles.

The system may further comprise an electronic data storage unit. The electronic data storage unit may be in electronic communication with the processor. The electronic data storage unit may be configured to store the image data feed or the data log.

The system may further comprise a reader. The reader may be operatively connected to the processor. The reader may be operatively connected to an electronic data storage unit. The reader may be configured to receive the image data feed or the data log. The reader may be operatively connected to the processor or the electronic data storage unit using wired or wireless communication. The reader may comprise a mobile device or a web interface.

The driver may be able to access a mobile application on a tablet or phone as a reader. The ELD connection may be in communication with a tablet or phone of the driver to provide hours of service (HOS) information to the driver. For example, the ELD connection may communicate with the tablet or phone by Bluetooth.

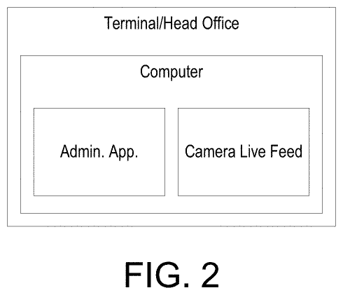

An administrator can review the information on the ELD system or the computer using a web application. FIG. 2 is a block diagram of a web application embodiment. The administrator can view a live feed of the cameras and access an administrator's application, such as from the terminal office or head office.

A web application can permit an administrators of the trucking company, vehicle owner, or another interested party to view all driver logs, find the location of the trucks, generate fuel consumption reports, and perform other functions.

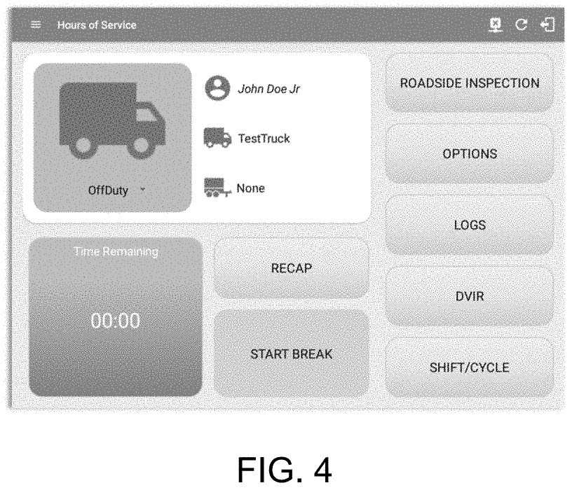

FIG. 4 is an exemplary GUI for a mobile application. If GPS location is available, the mobile application may automatically switch to night theme after calculating the sunset time of the latitude and longitude values. The color scheme for night theme can be turned on upon log-in and may affect all screens.

The mobile application also may include a Driver Vehicle Inspection Report (DVIR). Submission of the DVIR can be used to enable operation of the vehicle.

An embodiment can include GPS tracking of the vehicle. This can be shared with the web application view by administrators. Fleet location can be shared with the driver's mobile application or the web application viewed by administrators.

Vehicle diagnostics and malfunction reports can be shared with the driver's mobile application or the web application viewed by administrators.

Fuel consumption and mileage reports can be shared with the driver's mobile application or the web application viewed by administrators.

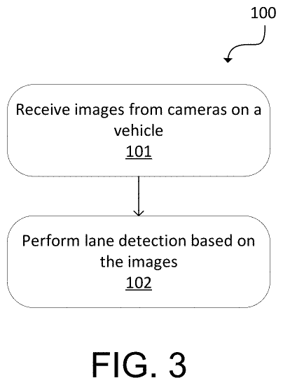

An embodiment may comprise a method. The method may comprise collecting one or more images; generating, from the one or more images, an image data feed; receiving, at a processor, the image data feed; and performing lane detection and object detection. FIG. 3 is a flowchart of an embodiment of a method 100. At 101, images from cameras disposed on a vehicle are received at a processor. The processor is used to perform lane detection using the images at 102. Performing the lane detection can include using a neural network (such as a neural network in a deep learning module).

The collecting or generating may be performed using a plurality of cameras disposed on a vehicle. The lane detection or object detection may be performed on the processor. The lane detection or object detection may use the image data feed.

Optionally, a driver can be alerted when the vehicle exits a lane determined by the lane detection. For example, this alert can be sent to the mobile application. An audible, tactile, or visual alert can be provided to the driver.

The method 100 also can include performing, using the processor, object detection on the images. Performing the object detection can include using a neural network.

Engine and video data can go to the cloud from the truck. Video data may be split, de-duplicated, and annotated. Engine data can be used for various self-driving algorithms in sync with the video data.

The object detection may include identifying and classifying another vehicle.

The method may further comprise performing deep learning. The deep learning may be performed using the processor. The deep learning may use the results of the lane detection or the object detection.

The method may further comprise generating a data log. The data log may be generating using a data logger. The data logger may be in electronic communication with a component of an engine of the vehicle. The component may be a monitoring system. The data logger may be an electronic data logging device.

The method may further comprise generating a data log.

The image data feed or the data log may be stored on an electronic data storage unit. The electronic data storage unit may be in electronic communication with the processor.

The method may further comprise alerting a drive of a lane exit. The lane exit alert may be based on a determination of a lane exit by the lane detection.

Data logged in systems and methods by the data logger may include engine data from an engine of the vehicle. Such data may include adapter data, ELD data, International Fuel Tax Agreement (IFTA) data, or statistical data.

Adapter data may include Connection Status, Adapter Version, Adapter Sleep Mode, Adapter LED Brightness, Adapter Name, Adapter Password, Adapter Error Messages, Engine Information (make, model, serial number, software ID), Cab Information, Transmission Information, Brakes Information, Engine VIN, Engine RPM, Vehicle Speed, Cruise Control Information, Truck Odometer, Engine Distance, Total Fuel Used, Total Idle Fuel Used, Average Fuel Economy, Instant Fuel Economy, Fuel Rate, Fuel Levels, Total Engine Hours, Total Engine Idle Hours, Coolant Temperature, Coolant Level, Intake Air Temperature, Oil Temperature, Transmission Temperature, Oil Pressure, Barometric Pressure, Intake Air Pressure, Brake Switch Setting, Brake Air Pressures, Parking Brake Setting, Clutch Switch Setting, Fan State, Percent Load, Percent Torque, Driver Percent Torque, Accelerator Pedal Position, Throttle Position, Battery Charging (volts), or Engine Faults.

ELD data may include Record IDs, Driver ID, Engine VIN, Start Engine, Start Driving, Driving, Stop Driving, Stop Engine, Custom, Record Data, Truck Odometer, Engine Distance, Engine Hours, GPS Latitude (if available), or GPS Longitude (if available).

IFTA data may include Record ID, IFTA, Record Data, Truck Odometer, Engine Distance, Total Fuel Used, GPS Latitude (if available), or GPS Longitude (if available)

Statistical data may include Record ID, Stat, Record Data, Engine Distance, Total Fuel Used, Idle Fuel Used, Total Engine Hours, or Idle Engine Hours.

An additional embodiment relates to a non-transitory computer-readable medium storing program instructions executable on a controller for performing a computer-implemented method for lane detection and/or object detection. An electronic data storage unit or other storage medium may contain non-transitory computer-readable medium that includes program instructions executable on a processor. The computer-implemented method may include any step(s) of any method(s) described herein.

Program instructions implementing methods such as those described herein may be stored on computer-readable medium, such as in the electronic data storage unit or other storage medium. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

An additional embodiment relates to a processor configured to operate any step(s) of any method(s) described herein.

An embodiment of a lane finding system is disclosed. This lane finding system is meant to be exemplary and not limiting in any way.

The lane finding system can compute the camera calibration matrix and distortion coefficients given a set of chessboard images, apply a distortion correction to raw images, use color transforms, gradients, etc., to create a thresholded binary image, apply a perspective transform to rectify binary image (“birds-eye view”), detect lane pixels and fit to find the lane boundary, determine the curvature of the lane and vehicle position with respect to center, warp the detected lane boundaries back onto the original image, and output visual display of the lane boundaries and numerical estimation of lane curvature and vehicle position.

Camera calibration can first be computed using chessboard images. It is assumed that the chessboard does not have a depth/height and is fixed on the (x, y) plane at z=0. Object points and image points can be calculated. “Object points” may be the (x, y, z) coordinates of the chessboard corners in a perfect scenario. img_points can be appended with the (x, y) pixel position of each of the corners in the image. The chessboard size is 9×6, but other sizes are possible. Various functions can be used to find the corners, draw the corners, or calibrate the camera. Some images may fail during calibration.

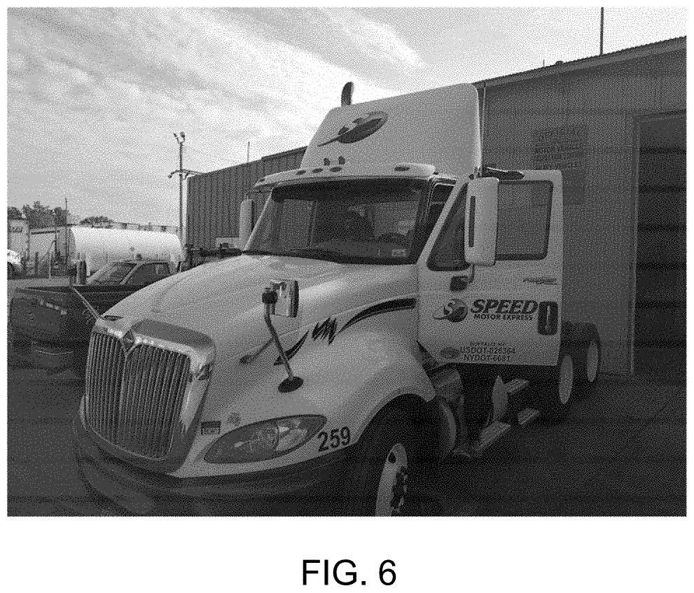

Object and image points can then be determined. This can be seen in FIG. 7.

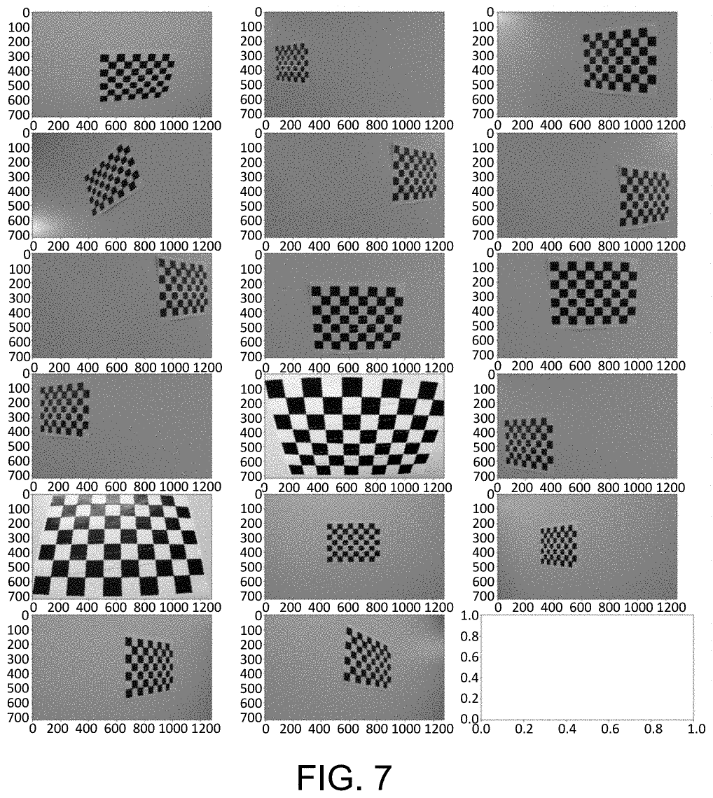

Distortion removal can be performed, as seen in FIG. 8.

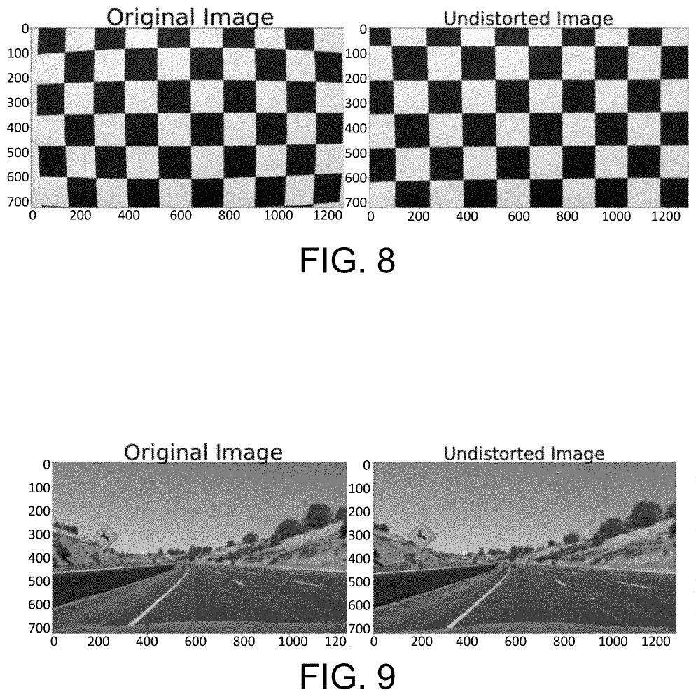

A real test image is undistorted in FIG. 9. Note the car on the left of the original image is clipped off.

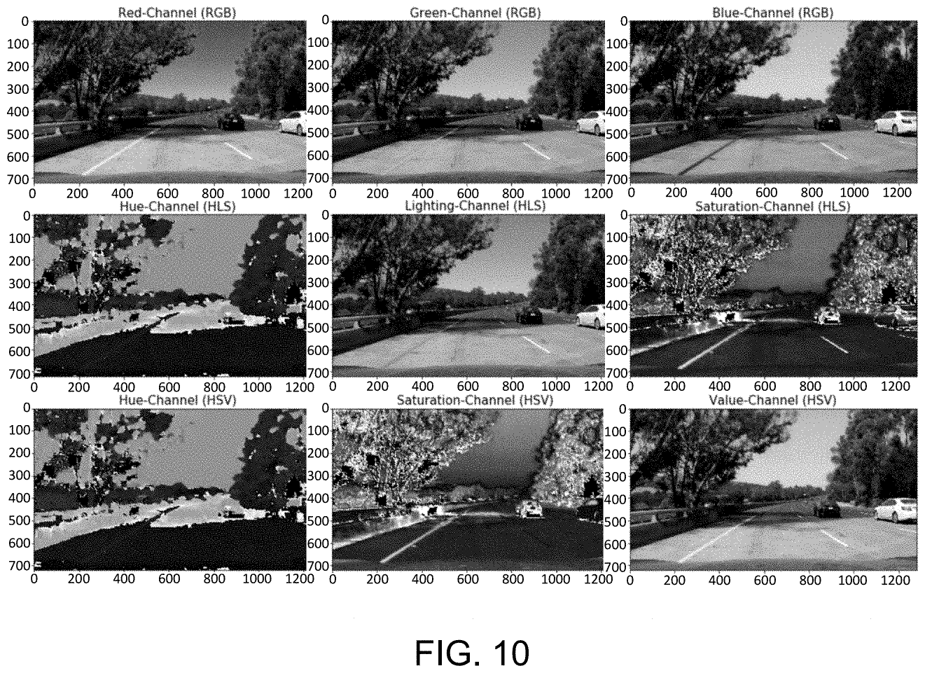

Different image channels can be viewed, as seen in FIG. 10.

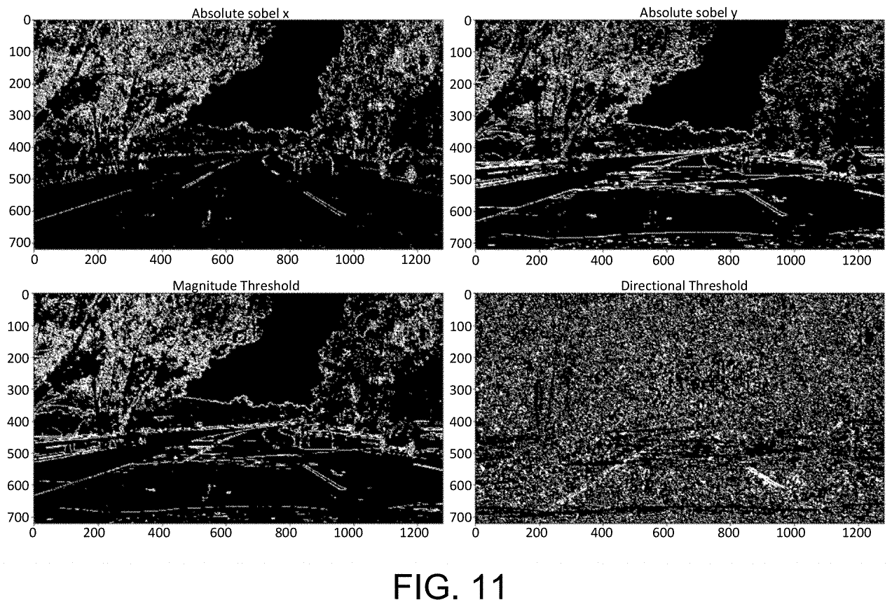

Gradient and color thresholds can be applied to detect different color lane lines, as seen in FIG. 11.

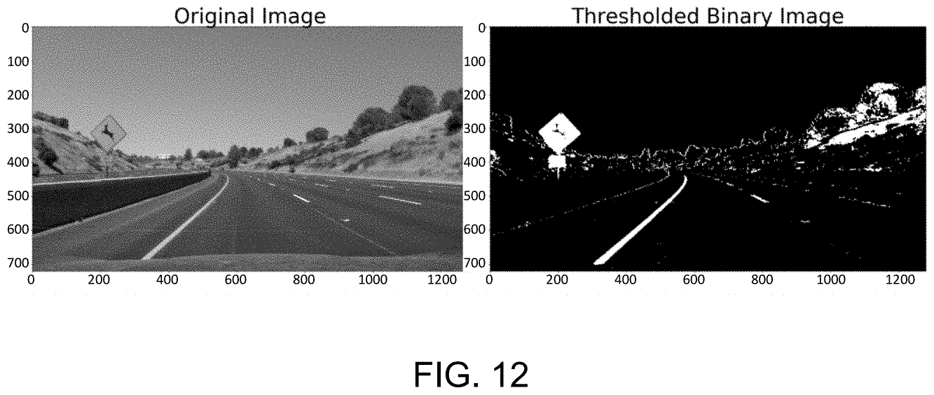

Approaches can be combined to undistort and extract edges. For example, the Sobel x operator, saturation of HLS channel, and changing hue of the HLS channel can be used. FIG. 12 shows original and thresholded binary images.

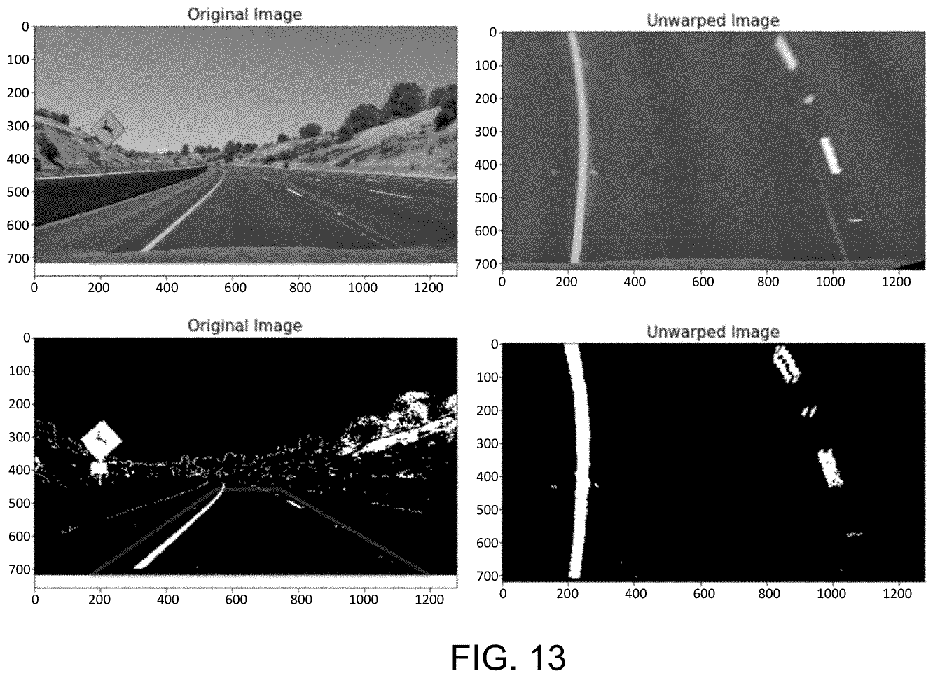

A perspective transform can be performed. This can transform the viewing angle. The road lanes look to converge in the image but a perspective transform tells us if the road lanes actually curving. Functions like getPerspectiveTransform, which is an OpenCV function that calculates a perspective transform from four pairs of the corresponding points, and warpPerspective, which is an OpenCV function that applies a perspective transformation to an image, can be used. This is illustrated in FIG. 13.

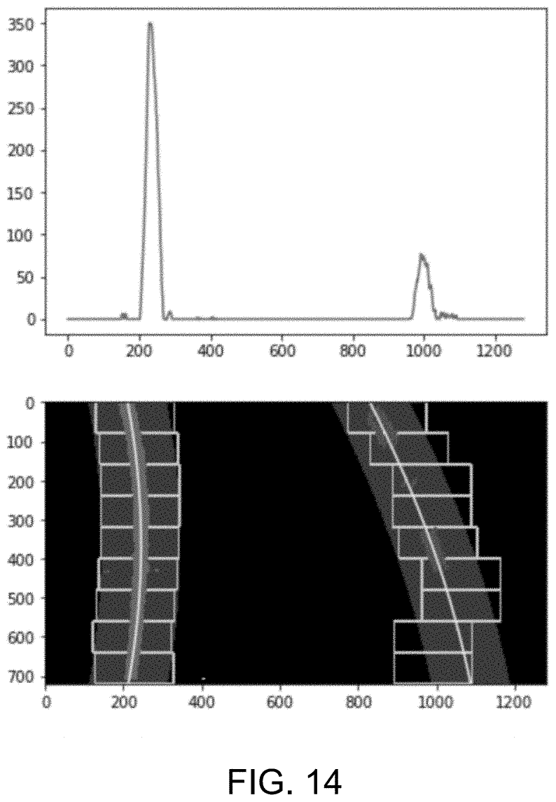

Lanes can be determined in warped images. An image histogram can be used to find two peaks. These peaks can be used as a starting point. A sliding window approach can be used to move vertically. See FIG. 14. The windows are the ROI for the left and right lanes. After the first frame, a highly targeted search may be performed for the next frame. This can help in case of camera temporary failure, sharp curves, or other turbulent conditions. If the prediction is wrong, the frame can be ignored. If the prediction is expected, it can be added to the previous and averaged.

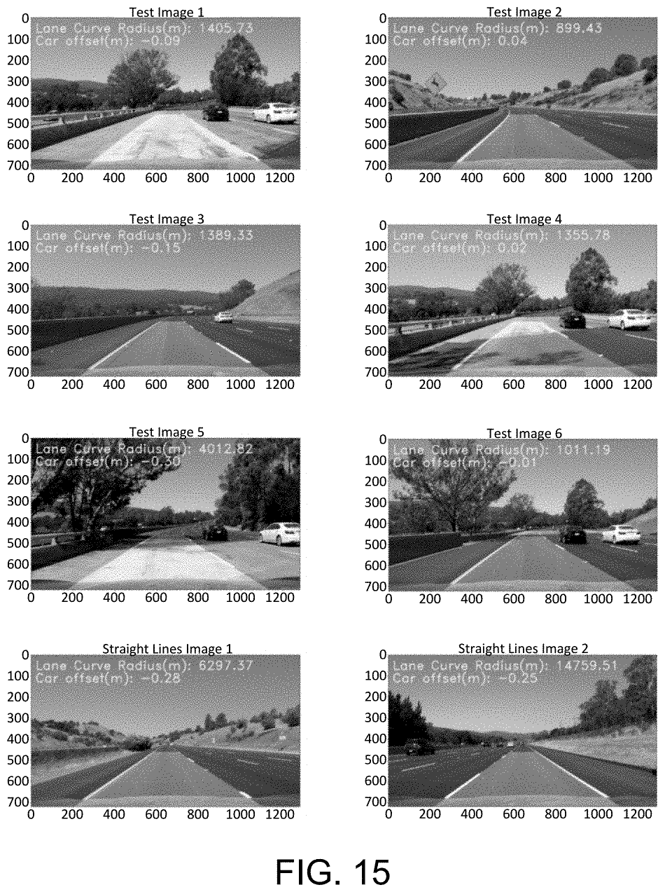

The lane quadrilateral can be plotted for all test images. This is shown in FIG. 15.

Deep learning is part of a broader family of machine learning methods based on learning representations of data. An observation (e.g., an image) can be represented in many ways such as a vector of intensity values per pixel, or in a more abstract way as a set of edges, regions of particular shape, etc. Some representations are better than others at simplifying the learning task (e.g., face recognition or facial expression recognition. Deep learning can provide efficient algorithms for unsupervised or semi-supervised feature learning and hierarchical feature extraction.

Research in this area attempts to make better representations and create models to learn these representations from large-scale unlabeled data. Some of the representations are inspired by advances in neuroscience and are loosely based on interpretation of information processing and communication patterns in a nervous system, such as neural coding which attempts to define a relationship between various stimuli and associated neuronal responses in the brain.

There are many variants of neural networks with deep architecture depending on the probability specification and network architecture, including, but not limited to, Deep Belief Networks (DBN), Restricted Boltzmann Machines (RBM), and Auto-Encoders. Another type of deep neural network, a CNN, can be used for image classification. Although other deep learning neural networks can be used, an exemplary embodiment of the present disclosure is described using a TensorFlow architecture to illustrate the concepts of a CNN. The actual implementation may vary depending on the size of images, the number of images available, and the nature of the problem. Other layers may be included in the object detection network besides the neural networks disclosed herein.

In an example, the neural network framework may be TensorFlow 1.0. The algorithm may be written in Python.

In an embodiment, the deep learning model is a machine learning model. Machine learning can be generally defined as a type of artificial intelligence (AI) that provides computers with the ability to learn without being explicitly programmed. Machine learning focuses on the development of computer programs that can teach themselves to grow and change when exposed to new data. Machine learning explores the study and construction of algorithms that can learn from and make predictions on data. Such algorithms overcome following strictly static program instructions by making data driven predictions or decisions, through building a model from sample inputs.

In some embodiments, the deep learning model is a generative model. A generative model can be generally defined as a model that is probabilistic in nature. In other words, a generative model is one that performs forward simulation or rule-based approaches. The generative model can be learned (in that its parameters can be learned) based on a suitable training set of data. In one embodiment, the deep learning model is configured as a deep generative model. For example, the model may be configured to have a deep learning architecture in that the model may include multiple layers, which perform a number of algorithms or transformations.

In another embodiment, the deep learning model is configured as a neural network. In a further embodiment, the deep learning model may be a deep neural network with a set of weights that model the world according to the data that it has been fed to train it. Neural networks can be generally defined as a computational approach, which is based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically consist of multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

In one embodiment, the deep learning model used for the maritime applications disclosed herein is configured as an AlexNet. For example, an AlexNet includes a number of convolutional layers (e.g., 5) followed by a number of fully connected layers (e.g., 3) that are, in combination, configured and trained to classify images. In another such embodiment, the deep learning model used for the maritime applications disclosed herein is configured as a GoogleNet. For example, a GoogleNet may include layers such as convolutional, pooling, and fully connected layers such as those described further herein configured and trained to classify images. While the GoogleNet architecture may include a relatively high number of layers (especially compared to some other neural networks described herein), some of the layers may be operating in parallel, and groups of layers that function in parallel with each other are generally referred to as inception modules. Other of the layers may operate sequentially. Therefore, GoogleNets are different from other neural networks described herein in that not all of the layers are arranged in a sequential structure. The parallel layers may be similar to Google's Inception Network or other structures.

In a further such embodiment, the deep learning model used for the maritime applications disclosed herein is configured as a Visual Geometry Group (VGG) network. For example, VGG networks were created by increasing the number of convolutional layers while fixing other parameters of the architecture. Adding convolutional layers to increase depth is made possible by using substantially small convolutional filters in all of the layers. Like the other neural networks described herein, VGG networks were created and trained to classify images. VGG networks also include convolutional layers followed by fully connected layers.

In some such embodiments, the deep learning model used for the maritime applications disclosed herein is configured as a deep residual network. For example, like some other networks described herein, a deep residual network may include convolutional layers followed by fully-connected layers, which are, in combination, configured and trained for image classification. In a deep residual network, the layers are configured to learn residual functions with reference to the layer inputs, instead of learning unreferenced functions. In particular, instead of hoping each few stacked layers directly fit a desired underlying mapping, these layers are explicitly allowed to fit a residual mapping, which is realized by feedforward neural networks with shortcut connections. Shortcut connections are connections that skip one or more layers. A deep residual net may be created by taking a plain neural network structure that includes convolutional layers and inserting shortcut connections, which thereby takes the plain neural network and turns it into its residual learning counterpart.

In a further such embodiment, the deep learning model used for the maritime applications disclosed herein includes one or more fully connected layers configured for classifying defects on the specimen. A fully connected layer may be generally defined as a layer in which each of the nodes is connected to each of the nodes in the previous layer. The fully connected layer(s) may perform classification based on the features extracted by convolutional layer(s), which may be configured as described further herein. The fully connected layer(s are configured for feature selection and classification. In other words, the fully connected layer(s) select features from a feature map and then classify the objects in the image(s) based on the selected features. The selected features may include all of the features in the feature map (if appropriate) or only some of the features in the feature map.

If the deep learning model outputs a classification for an object detected in the image, the deep learning model may output an image classification, which may include a classification result per image with a confidence associated with each classification result. The results of the image classification can also be used as described further herein. The image classification may have any suitable format (such as an image or object ID, an object description such as “vehicle,” etc.). The image classification results may be stored and used as described further herein.

In some embodiments, the information determined by the deep learning model includes features of the images extracted by the deep learning model. In one such embodiment, the deep learning model includes one or more convolutional layers. The convolutional layer(s) may have any suitable configuration known in the art and are generally configured to determine features for an image as a function of position across the image (i.e., a feature map) by applying a convolution function to the input image using one or more filters. In this manner, the deep learning model (or at least a part of the deep learning model) may be configured as a CNN. For example, the deep learning model may be configured as a CNN, which is usually stacks of convolution and pooling layers, to extract local features. The embodiments described herein can take advantage of deep learning concepts such as a CNN to solve the normally intractable representation inversion problem. The deep learning model may have any CNN configuration or architecture known in the art. The one or more pooling layers may also have any suitable configuration known in the art (e.g., max pooling layers) and are generally configured for reducing the dimensionality of the feature map generated by the one or more convolutional layers while retaining the most important features.

The features determined the deep learning model may include any suitable features described further herein or known in the art that can be inferred from the input described herein (and possibly used to generate the output described further herein). For example, the features may include a vector of intensity values per pixel. The features may also include any other types of features described herein, e.g., vectors of scalar values, vectors of independent distributions, joint distributions, or any other suitable feature types known in the art.

In general, the deep learning model described herein is a trained deep learning model. For example, the deep learning model may be previously trained by one or more other systems and/or methods. The deep learning model is already generated and trained and then the functionality of the model is determined as described herein, which can then be used to perform one or more additional functions for the deep learning model.

In an exemplary embodiment, the features are extracted from images using a CNN. The CNN has one or more convolutional layers, and each convolutional layer is usually followed by a subsampling layer. Convolutional networks are inspired by visual systems structure. The visual cortex contains a complex arrangement of cells. These cells are sensitive to small sub-regions of the visual field, called a receptive field. A small region in the input is processed by a neuron in the next layer. Those small regions are tiled up to cover the entire input images.

Each node in a convolutional layer of the hierarchical probabilistic graph can take a linear combination of the inputs from nodes in the previous layer, and then applies a nonlinearity to generate an output and pass it to nodes in the next layer. To emulate the mechanism of the visual cortex, CNNs first convolve the input image with a small filter to generate feature maps (each pixel on the feature map is a neuron corresponds to a receptive field). Each map unit of a feature map is generated using the same filter. In some embodiments, multiple filters may be used and a corresponding number of feature maps will result. A subsampling layer computes the max or average over small windows in the previous layer to reduce the size of the feature map, and to obtain a small amount of shift invariance. The alternate between convolution and subsampling can be repeated multiple times. The final layer is fully connected traditional neural network. From bottom to top, the input pixel value was abstracted to local edge pattern to object part to final object concept.

As stated above, although a CNN is used herein to illustrate the architecture of an exemplary deep learning system, the present disclosure is not limited to a CNN. Other variants of deep architectures may be used in embodiments; for example, Auto-Encoders, DBNs, and RBMs, can be used to discover useful features from unlabeled images.

CNNs may comprise of multiple layers of receptive fields. These are small neuron collections, which process portions of the input image or images. The outputs of these collections are then tiled so that their input regions overlap, to obtain a better representation of the original image. This may be repeated for every such layer. Tiling allows CNNs to tolerate translation of the input image. CNN may have 3D volumes of neurons. The layers of a CNN may have neurons arranged in three dimensions: width, height and depth. The neurons inside a layer are only connected to a small region of the layer before it, called a receptive field. Distinct types of layers, both locally and completely connected, are stacked to form a CNN architecture. CNNs exploit spatially local correlation by enforcing a local connectivity pattern between neurons of adjacent layers. The architecture thus ensures that the learnt filters produce the strongest response to a spatially local input pattern. Stacking many such layers leads to non-linear filters that become increasingly global (i.e., responsive to a larger region of pixel space). This allows the network to first create good representations of small parts of the input, and then assemble representations of larger areas from them. In CNNs, each filter is replicated across the entire visual field. These replicated units share the same parameterization (weight vector and bias) and form a feature map. This means that all the neurons in a given convolutional layer detect exactly the same feature. Replicating units in this way allows features to be detected regardless of their position in the visual field, thus constituting the property of translation invariance.

Together, these properties allow CNNs achieve better generalization on vision problems. Weight sharing also helps by dramatically reducing the number of free parameters being learnt, thus lowering the memory requirements for running the network. Decreasing the memory footprint allows the training of larger, more powerful networks. CNNs may include local or global pooling layers, which combine the outputs of neuron clusters. Pooling layers may also consist of various combinations of convolutional and fully connected layers, with pointwise nonlinearity applied at the end of or after each layer. A convolution operation on small regions of input is introduced to reduce the number of free parameters and improve generalization. One advantage of CNNs is the use of shared weight in convolutional layers, which means that the same filter (weights bank) is used for each pixel in the layer. This also reduces memory footprint and improves performance.

A CNN architecture may be formed by a stack of distinct layers that transform the input volume into an output volume (e.g., holding class scores) through a differentiable function. A few distinct types of layers may be used. The convolutional layer has a variety of parameters that consist of a set of learnable filters (or kernels), which have a small receptive field, but extend through the full depth of the input volume. During the forward pass, each filter may be convolved across the width and height of the input volume, computing the dot product between the entries of the filter and the input and producing a two-dimensional activation map of that filter. As a result, the network learns filters that activate when they see some specific type of feature at some spatial position in the input. By stacking the activation maps for all filters along the depth dimension, a full output volume of the convolution layer is formed. Every entry in the output volume can thus also be interpreted as an output of a neuron that looks at a small region in the input and shares parameters with neurons in the same activation map.

When dealing with high-dimensional inputs such as images, it may be impractical to connect neurons to all neurons in the previous volume because such a network architecture does not take the spatial structure of the data into account. CNNs may exploit spatially local correlation by enforcing a local connectivity pattern between neurons of adjacent layers. For example, each neuron is connected to only a small region of the input volume. The extent of this connectivity is a hyperparameter called the receptive field of the neuron. The connections may be local in space (along width and height), but always extend along the entire depth of the input volume. Such an architecture ensures that the learnt filters produce the strongest response to a spatially local input pattern. In one embodiment, training the CNN includes using transfer learning to create hyperparameters for each CNN. Transfer learning may include training a CNN on a very large dataset and then use the trained CNN weights as either an initialization or a fixed feature extractor for the task of interest.

Three hyperparameters can control the size of the output volume of the convolutional layer: the depth, stride and zero-padding. Depth of the output volume controls the number of neurons in the layer that connect to the same region of the input volume. All of these neurons will learn to activate for different features in the input. For example, if the first CNN layer takes the raw image as input, then different neurons along the depth dimension may activate in the presence of various oriented edges, or blobs of color. Stride controls how depth columns around the spatial dimensions (width and height) are allocated. When the stride is 1, a new depth column of neurons is allocated to spatial positions only 1 spatial unit apart. This leads to heavily overlapping receptive fields between the columns, and to large output volumes. Conversely, if higher strides are used then the receptive fields will overlap less and the resulting output volume will have smaller dimensions spatially. Sometimes it is convenient to pad the input with zeros on the border of the input volume. The size of this zero-padding is a third hyperparameter. Zero padding provides control of the output volume spatial size. In particular, sometimes it is desirable to preserve exactly the spatial size of the input volume.

In some embodiments, a parameter-sharing scheme may be used in layers to control the number of free parameters. If one patch feature is useful to compute at some spatial position, then it may also be useful to compute at a different position. In other words, denoting a single 2-dimensional slice of depth as a depth slice, neurons in each depth slice may be constrained to use the same weights and bias.

Since all neurons in a single depth slice may share the same parametrization, then the forward pass in each depth slice of the layer can be computed as a convolution of the neuron's weights with the input volume. Therefore, it is common to refer to the sets of weights as a filter (or a kernel), which is convolved with the input. The result of this convolution is an activation map, and the set of activation maps for each different filter are stacked together along the depth dimension to produce the output volume.

Sometimes, parameter sharing may not be effective, for example, when the input images to a CNN have some specific centered structure, in which completely different features are expected to be learned on different spatial locations.

Another important concept of CNNs is pooling, which is a form of non-linear down-sampling. There are several non-linear functions to implement pooling among which max pooling is one. Max pooling partitions the input image into a set of non-overlapping rectangles and, for each such sub-region, outputs the maximum. Once a feature has been found, its exact location may not be as important as its rough location relative to other features. The function of the pooling layer may be to progressively reduce the spatial size of the representation to reduce the amount of parameters and computation in the network, and hence to also control overfitting. A pooling layer may be positioned in-between successive cony layers in a CNN architecture.

Another layer in a CNN may be a ReLU (Rectified Linear Units) layer. This is a layer of neurons that applies a non-saturating activation function. A ReLU layer may increase the nonlinear properties of the decision function and of the overall network without affecting the receptive fields of the convolution layer.

Finally, after several convolutional and/or max pooling layers, the high-level reasoning in the neural network is completed via fully connected layers. Neurons in a fully connected layer have full connections to all activations in the previous layer. Their activations can hence be computed with a matrix multiplication followed by a bias offset.

In some embodiments, dropout techniques may be utilized to prevent overfitting. As referred to herein, dropout techniques are a regularization technique for reducing overfitting in neural networks by preventing complex co-adaptations on training data. The term “dropout” refers to dropping out units (both hidden and visible) in a neural network. For example, at each training stage, individual nodes may be either “dropped out” of the CNN with probability 1-p or kept with probability p, so that a reduced CNN remains. In some embodiments, incoming and outgoing edges to a dropped-out node may also be removed. Only the reduced CNN is trained. Removed nodes may then be reinserted into the network with their original weights.

In training stages, the probability a hidden node will be retained (i.e., not dropped) may be approximately 0.5. For input nodes, the retention probability may be higher. By avoiding training all nodes on all training data, dropout decreases overfitting in CNNs and significantly improves the speed of training.

Many different types of CNNs may be used in embodiments of the present disclosure. Different CNNs may be used based on certain information inputs, applications, or other circumstances.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Although the present disclosure has been described with respect to one or more particular embodiments, it will be understood that other embodiments of the present disclosure may be made without departing from the scope of the present disclosure.

What is claimed is:

1. A system comprising:
a plurality of cameras disposed on a vehicle configured to collect one or more images and therewith generate an image data feed; and
a processor in electronic communication with the cameras configured to receive the image data feed therefrom, wherein the processor is configured to execute one or more programs comprising:
a lane detection module configured to perform lane detection using the image data feed; and
an object detection module configured to perform object detection using the image data feed.

2. The system of claim 1, wherein the object detection module is configured to identify and classify other vehicles.

3. The system of claim 1, wherein the programs further comprise a deep learning module, wherein the lane detection module and/or the object detection module use the deep learning module during operation to train a lane detection algorithm and/or an object detection algorithm.

4. The system of claim 1, further comprising a data logger in electronic communication with a component of an engine of the vehicle.

5. The system of claim 4, wherein the component comprises a monitoring system.

6. The system of claim 4, wherein the data logger comprises an electronic logging device.

7. The system of claim 4, wherein the data logger is configured to generate a data log.

8. The system of claim 7, further comprising an electronic data storage unit in electronic communication with the processor and configured to store the image data feed or the data log.

9. The system of claim 7, further comprising a reader operatively connected to the processor and configured to receive the image data feed or the data log.

10. The system of claim 9, wherein the reader is operatively connected to the processor via wired or wireless communication.

11. The system of claim 9, wherein the reader comprises a mobile device or a web interface.

12. A method comprising:
collecting, using a plurality of cameras disposed on a vehicle, one or more images;
generating, using the plurality of cameras, from the one or more images, an image data feed;
receiving, at a processor, the image data feed; and
performing, using the processor:
lane detection using the image data feed; and
object detection using the image data feed.

13. The method of claim 12, wherein performing object detection includes identifying and classifying another vehicle.

14. The method of claim 12, further comprising performing, using the processor, deep learning using the results of the lane detection and/or the object detection to train a lane detection algorithm and/or an object detection algorithm.

15. The method of claim 12, further comprising generating, using a data logger in electronic communication with a component of an engine of the vehicle, a data log.

16. The method of claim 15, wherein the component comprises a monitoring system.

17. The method of claim 15, wherein the data logger comprises an electronic logging device.

18. The method of claim 12, further comprising generating a data log.

19. The method of claim 18, further comprising storing the image data feed or the data log on an electronic data storage unit in electronic communication with the processor.

20. The method of claim 12, further comprising, detecting, using the lane detection, a lane exit and alerting a driver of the lane exit.
